(19) United States
(12) Patent Application Publication
(10) Pub. No.: US 2018/0263449 A1
(43) Pub. Date: Sep. 20, 2018

(54) FLOOR CLEANING SYSTEM AND METHOD FOR CLEANING A FLOOR SURFACE

(71) Applicant: Alfred Kärcher GmbH & Co. KG, Winnenden (DE)

(72) Inventors: Christian Rosskopf, Otting (DE); Markus Duenne, Vreden (DE); Norman Kohler, Reutlingen (DE); Karl Engelbert Wenzel, Berglen (DE)

(21) Appl. No.: 15/986,467

(22) Filed: May 22, 2018

Related U.S. Application Data
(63) Continuation of application No. PCT/EP2016/077286, filed on Nov. 10, 2016.

(30) Foreign Application Priority Data
Nov. 23, 2015 (DE) 10 2015 120 221.2

(51) Int. Cl. A47L 9/28; G06F 3/01; G06F 3/041; G06F 3/16

(52) U.S. Cl. CPC A47L 9/2852; A47L 9/2815; A47L 9/2826; A47L 2201/04; G06F 3/017; G06F 3/041; G06F 3/167; A47L 9/2857

(57) ABSTRACT

A floor cleaning system that includes a self-propelled and self-steering floor cleaning apparatus for cleaning a floor surface and a portable accessory device is disclosed. The floor cleaning apparatus includes a control unit, a controllable chassis, at least one cleaning unit, a localization member and a communication member. The portable accessory device includes an operating unit, a control unit and a communication member, wherein a cleaning order to the apparatus is triggerable by the user via the operating unit and said cleaning order is transmittable to the floor cleaning apparatus to clean the floor surface at the user location, wherein position information relating to the user location is transferable to the floor cleaning apparatus and wherein the floor cleaning apparatus is movable to the user location and the floor surface at the user location is cleanable in accordance with the cleaning order by the at least one cleaning unit.

### CROSS-REFERENCE TO RELATED APPLICATIONS

This application is a continuation of international application number PCT/EP2016/077286 filed on Nov. 10, 2016, which claims the benefit of German application No. 10 2015 120 221.2 filed on Nov. 23, 2015, each of which is incorporated by reference in its entirety.

### FIELD OF THE INVENTION

The invention relates to a floor cleaning system, comprising a self-propelled and self-steering floor cleaning apparatus for cleaning a floor surface, which floor cleaning apparatus comprises a control unit, a controllable chassis, at least one cleaning unit, a localization member and a communication member, and comprising a portable accessory device for a user that comprises an operating unit, a control unit and a communication member.

Furthermore, the invention relates to a method for cleaning a floor surface.

### BACKGROUND OF THE INVENTION

In a floor cleaning system of the kind mentioned at the outset, the floor surface can be cleaned autonomously by the floor cleaning apparatus. The floor cleaning apparatus can move over the floor surface by way of the chassis, and the floor surface can be cleaned using the at least one cleaning unit. Examples of such floor cleaning apparatuses are robotic vacuum cleaners or robotic sweeper/vacuum cleaners. Autonomously moving scrubbing machines or sweeping machines are also conceivable.

It is known that a portable accessory device for a user can be used for transferring an operating instruction to the floor cleaning apparatus. By way of example, WO 2009/132317 discloses the use of a handheld computer or a mobile phone in order to transfer information to the floor cleaning apparatus. Such information includes, for example, path planning information for a cleaning path which is to be executed by the floor cleaning apparatus.

EP 2 387 931 A2 describes a method for cleaning a floor surface in which a user examines, from a remote control center, images of the floor surface that have been created and transmitted by the floor cleaning apparatus. The user can decide from these images whether or not the floor surface is in need of cleaning at a position that is captured by the image. If so, an instruction is sent from the user to the floor cleaning apparatus in order to clean the floor surface on the basis of a predeterminable cleaning program.

An object underlying the present invention is to provide a floor cleaning system of the kind mentioned at the outset and a method for cleaning the floor surface by which the floor surface can be cleaned in a targeted and needs-based manner.

### SUMMARY OF THE INVENTION

In a first aspect of the invention, a floor cleaning system comprises a self-propelled and self-steering floor cleaning apparatus for cleaning a floor surface, which floor cleaning apparatus comprises a control unit, a controllable chassis, at least one cleaning unit, a localization member and a communication member. The floor cleaning system comprises a portable accessory device for a user that comprises an operating unit, a control unit and a communication member. A cleaning order to the floor cleaning apparatus can be triggered by the user via the operating unit and said cleaning order can be transmitted to the floor cleaning apparatus to clean the floor surface at the user location. Position information relating to the user location can be transferred to the floor cleaning apparatus and wherein the floor cleaning apparatus can be moved to the user location and the floor surface at the user location can be cleaned in accordance with the cleaning order by way of the at least one cleaning unit.

In a second aspect of the invention, in a method for cleaning a floor surface a floor cleaning system in accordance with the first aspect is used. A cleaning order is triggered to the floor cleaning apparatus by the user via the operating unit of the accessory device, and the cleaning order is transmitted to the floor cleaning apparatus to clean the floor surface at the user location. Position information relating to the user location is transferred to the floor cleaning apparatus, and the floor cleaning apparatus moves to the user location and cleans the floor surface by way of the at least one cleaning unit in accordance with the cleaning order.

### BRIEF DESCRIPTION OF THE DRAWINGS

The foregoing summary and the following description may be better understood in conjunction with the drawing figures, of which:

FIG. 1 shows a schematic representation of a floor cleaning system in accordance with the invention, comprising a floor cleaning apparatus, a portable accessory device and position landmarks, wherein a method in accordance with the invention can be carried out by way of the floor cleaning system;

FIG. 2 shows a user creating an image of a floor surface having dirt on it for creating a cleaning order to the floor cleaning apparatus;

FIG. 3 shows the floor cleaning apparatus about to clean the floor surface for removing the dirt;

FIG. 4 shows the floor cleaning apparatus after cleaning the floor surface; and

FIG. 5 shows a flow chart of an advantageous exemplary embodiment of the method.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a floor cleaning system, comprising a self-propelled and self-steering floor cleaning apparatus for cleaning a floor surface, which floor cleaning apparatus comprises a control unit, a controllable chassis, at least one cleaning unit, a localization member and a communication member, and comprising a portable accessory device for a user that comprises an operating unit, a control unit and a communication member. A cleaning order to the floor cleaning apparatus can be triggered by the user via the operating unit and said cleaning order can be transmitted to the floor cleaning apparatus to clean the floor surface at the user location. Position information relating to the user location can be transferred to the floor cleaning apparatus and wherein the floor cleaning apparatus can be moved to the user location and the floor surface at the user location can be cleaned in accordance with the cleaning order by way of the at least one cleaning unit.

In the floor cleaning system in accordance with the invention, it is rendered possible for a user to transmit a targeted cleaning order to the floor cleaning apparatus and thereby trigger a needs-based cleaning action on the floor surface. The special feature is that the cleaning order relates to the user location on the floor surface. The user location is the location of use whereto the floor cleaning apparatus is to move in order to clean the floor surface there. Therefore the user location may be referred to in particular as the location of cleaning order creation or as the location of cleaning order origin. This remains unaltered even if the user moves on to a different location on the floor surface before or after dispatching the cleaning order. Accordingly, the words “cleaning of the floor surface in accordance with the cleaning order” as used herein are to be taken to mean in particular that the floor cleaning apparatus moves to the user location and cleans the floor surface at the user location. It is understood that the user location preferably is not to be regarded by the floor cleaning system as being punctual in a geometric sense, but rather is considered as having a certain spatial extension. The spatial extension may for example be a few square meters or within a radius of a few meters (for example approximately 1 m to 3 m) around the user's exact position.

The invention is particularly suited for use in buildings such as railway stations, airports, supermarkets or shopping centers, which can have floor surfaces of considerable size. The use of the floor cleaning system is not primarily directed towards giving the floor surface of such a building a complete and full-coverage clean. Rather, the advantage of the invention is that isolated spots of dirt on the floor surface can be cleaned in a targeted manner when needed. For example, if a supervisor or a staff member in such a building notices dirt, he or she can transmit a cleaning order to the floor cleaning apparatus via the portable accessory device. On the one hand, this is possible when the supervisor inspects the floor surface for possible dirt with the objective of having residual dirt removed. On the other hand, the advantage of the invention is precisely that supervisors or staff members who are going about their usual work and notice dirt can in passing order the spatially localized cleaning of the floor surface at the user location. This can even be taken in the literal sense of “on the fly”. A typical application for this is, for example, dirt formed from a fallen and ruptured food package in a supermarket or animal excrement in a railway station.

The cleaning order can be transferred from the accessory device to the floor cleaning apparatus directly or via an intermediary cleaning center which has under its administration a plurality of floor cleaning apparatuses for example. The center could forward the cleaning order to the next-nearest floor cleaning apparatus.

The cleaning order is transferred wirelessly, for example via a radio communication link over a mobile phone network, the internet etc.

Preferably, the position information can be transmitted from the accessory device, together with or as part of the cleaning order. In this way, the cleaning order contains the complete information for the floor cleaning apparatus to move to the user location and clean the floor surface there. Separate sending of position information can be dispensed with.

It may even be provided that position information alone is transmitted from the accessory device to the floor cleaning apparatus and that the position information alone forms the cleaning order and is interpreted as such.

The user location can be predeterminable at the accessory device by a user via the operating unit, whereby the user can provide the position information.

Advantageously, the position information can be transmitted from the accessory device to the floor cleaning apparatus without further action needed by the user in order to make it easier for a user to handle the floor cleaning apparatus.

It is advantageous for the accessory device to comprise a localization member by way of which the user location can be determined for providing the position information based on at least one of the following:
the position of the accessory device in a relative reference system which is defined on the basis of at least one position landmark;
the position of the accessory device in an absolute reference system.

Advantageously, the accessory device can determine its position in a relative reference system and/or in an absolute reference system by way of the localization member. For defining a relative reference system, one or more position landmarks, known as “beacons”, are used. For example, a plurality of position landmarks can be positioned on, or in a defined spatial relationship to, the floor surface, wherein, via the localization member, the position of the accessory device can be determined relative to the position landmarks and hence in the reference system defined by these. Alternatively or in addition, an absolute position can be determinable, for example in a satellite-based reference system, such as GPS or the like. The accuracy of the position determination (spatial resolution) is preferably less than approximately 2 m, preferably approximately 1 m or less.

The floor cleaning system can comprise a localization member by way of which the position of the user can be determined, wherein the position information can be transmitted from the localization member to the floor cleaning apparatus upon request thereof. In addition or alternatively to the transmission of the position information from the accessory device, it is conceivable for the floor cleaning apparatus, upon receipt of a cleaning order, to send a request regarding the position information to the localization member, for example the above-mentioned center, in order to determine the user location. The localization member can, for example, locate the accessory device in a relative reference system and send corresponding information to the floor cleaning apparatus.

It is advantageous for the accessory device to comprise a storage member in which a map of the floor surface is stored, and a localization member for determining the user location within the map for providing the position information. For example, the map is stored in spatially linked relation with an indication relating to the relative reference system so that the position information relates to the indication of the user location within the map (for example in the sense of a grid square) after a position could be determined in the relative reference system. It is also conceivable for the accessory device to be able to detect, in images of the floor surface, characteristic features which are stored as landmarks in the map. By locating the landmarks in the map, the user location can be determined within the map.

It proves advantageous for the location of the floor cleaning apparatus to be determinable by way of the localization member thereof in the relative reference system and/or in the absolute reference system and/or in a map of the floor surface which is stored in a storage member of the floor cleaning apparatus. Analogously to what has been described above using the accessory device as an example, provision may be made for the position of the floor cleaning apparatus to be able to be located via the localization member on the basis of at least one position landmark. It is thereby possible for position information about the user location to be compared directly with the position of the floor cleaning apparatus in the relative reference system and for the floor cleaning apparatus to be guided to the user location. The same applies analogously to the position information in the absolute reference system and/or to position information in a map of the floor surface. Position information relating to the map can be compared with the position of the floor cleaning apparatus in the map so that the floor cleaning apparatus can be moved to the user location.

The localization member of the accessory device and/or the localization member of the floor cleaning apparatus are preferably configured for interacting with radio position landmarks, in particular BLUETOOTH® position landmarks, and/or optical position landmarks.

Preferably, the floor cleaning system comprises at least one position landmark for defining a relative reference system. This may be, for example, a radio position landmark, in particular a BLUETOOTH®position landmark. Advantageously, the at least one position landmark is positioned in a defined spatial relationship to the floor surface and spatially linked with a map thereof, which map is stored in the accessory device and/or in the floor cleaning apparatus. However, this is not mandatory for the operation of the invention.

It proves advantageous if the accessory device comprises an imaging unit with which an image of the floor surface can be created and if at least one of the following can be performed:
the image is transferred to the floor cleaning apparatus, wherein, by way of the localization member thereof, the user location can be determined on the basis of characteristic features in the image;
the user location is determined on the basis of characteristic features in the image by way of a localization member of the accessory device.

Via the imaging unit, which is or comprises a digital camera in particular, the user can create an image of the floor surface. Preferably, the user will simultaneously therewith image the dirt that is to be removed. The image can be transferred from the accessory device to the floor cleaning apparatus. Characteristic features contained in the image can be located by the localization member of the accessory device and/or that of the floor cleaning apparatus. Based on the extracted characteristic features, the localization member determines the position information so that the user location can be located and the floor surface cleaned there. In particular, this provides the possibility of transmitting the position information from the accessory device to the floor cleaning apparatus as part of the image of the floor surface and of realizing no further localization of the accessory device in the relative and/or absolute reference system. However, it is of course possible for an image of the floor surface to be created and transferred to the floor cleaning apparatus by the user by way of the accessory device, wherein the position information is transmitted in addition to the image, for example in the relative and/or absolute reference system.

The possibility of transferring an image from the accessory device to the floor cleaning apparatus enables a particularly advantageous embodiment of the floor cleaning system to be implemented. Preferably, the floor cleaning apparatus takes the receipt of an optical image of the floor surface, transmitted from the accessory device, as a cleaning order to clean the floor surface at the position shown in the image. Correspondingly, in an advantageous embodiment, provision may be made for merely an image of the floor surface to be transmitted to the floor cleaning apparatus, said image advantageously also comprising the spot of dirt. The position information is extracted and the user location determined based on at least one characteristic feature of the image.

The floor cleaning apparatus preferably comprises at least one sensor unit in order to be able to sense and analyze the environment of the floor cleaning apparatus. By way of example, the sensor unit is or comprises an optical sensor unit, such as the imaging unit mentioned hereinafter.

The floor cleaning apparatus preferably comprises an imaging unit for creating images of the environment, advantageously wherein, by way of the floor cleaning apparatus, on the basis of the localization member thereof, its own location within the environment is determinable on the basis of said images. Correspondingly, the floor cleaning apparatus can preferably optically navigate the environment. Characteristic features of the images created by the imaging unit, particularly a digital camera, are for example linked to landmarks which are stored in a map stored in the floor cleaning apparatus. By comparing the characteristic features with the landmarks, the floor cleaning apparatus is able to determine its own position within the map. The position of the floor cleaning apparatus determined on the basis of optical imaging can be linked in particular to position information which is obtained using the relative reference system with position landmarks.

An imaging unit of the floor cleaning apparatus can also comprise an optical scanner, such as a laser scanner.

The image can be a one-dimensional, two-dimensional or three-dimensional image or data set.

Advantageously, the floor cleaning system may comprise, in the accessory device and/or in the floor cleaning apparatus, at least one dirt detection member for locating dirt in an image of the floor surface that has been created by an imaging unit of the accessory device or of the floor cleaning apparatus and for providing corresponding dirt information. This allows dirt in the image of the floor surface to be automatically located by the corresponding dirt detection member. In combination with the position information, this provides for an even better determination of the spatial location of the dirt for an even more targeted clean on the floor surface.

Preferably, the type of dirt can be detected by the dirt detection member so that the floor cleaning apparatus cannot only be provided with information about the location of cleaning but also with dirt information indicating the dirt that is to be removed.

It is preferred that, on the basis of the dirt information, the spot of dirt can be visited in a targeted manner by the floor cleaning apparatus for cleaning. In an advantageous embodiment, the position information is transferred together with the cleaning order in one of the ways described above, the floor cleaning apparatus moves to the user location and, by way of the dirt detection member, automatically detects the dirt in images of the floor surface, visits the spot of dirt in a targeted manner and cleans the floor surface.

Furthermore, the images of the floor surface preferably comprise information relating to the nature of the floor surface. Based on the information relating to the nature of the floor surface, the floor cleaning apparatus is for example able to determine whether, and if so which, sections of the floor surface may not be driven on and/or cleaned. Alternatively or in addition, at least one cleaning unit and/or at least one cleaning pattern or cleaning path can be preset depending on the information relating to the nature of the floor surface.

It is advantageous for the cleaning order to comprise dirt information relating to a type of dirt on the floor surface and/or a cleaning instruction comprising information relating to the preselection and/or setting of at least one cleaning unit. This makes for an even more needs-based cleaning of the floor surface.

Provision may be made for the dirt information and/or the cleaning instruction to be predeterminable by the user at the operating unit. For example, options for the selection of a type of dirt and/or for the cleaning instruction can be displayed to and selected by the user at the operating unit.

In particular, it is advantageously possible that, depending on the dirt information, a cleaning mode can be set or selected by the floor cleaning apparatus prior to cleaning, for example at least one cleaning unit and/or at least one cleaning pattern or cleaning path.

It is advantageous if at least one of the following can be performed by the floor cleaning apparatus after execution of the cleaning order:
the floor surface is checked for cleanliness;
a message is sent to the accessory device for signaling the user that the floor surface has been cleaned at least once.

The floor cleaning apparatus can comprise at least one sensor unit for checking the floor surface for cleanliness. For example, the sensor unit can be formed by or comprise the imaging unit. For example, images of the floor surface are captured before and after cleaning and are compared with one another by the floor cleaning apparatus. Alternatively or in addition, reference images showing a cleaned floor surface can be stored in a storage member of the floor cleaning apparatus for purposes of comparison. For example, the sensor unit can also comprise one or more particle sensors in order to determine the size and/or number of particles in a suction stream and decide, on the basis of such information, whether or not the floor surface is sufficiently clean.

Advantageously, if it is determined that the floor surface is not sufficiently clean, at least one further cleaning of the floor surface can be performed by the floor cleaning apparatus.

It is advantageous if a message can be transmitted from the floor cleaning apparatus to the accessory device for signaling the user if no dirt can be located at the user location. On the one hand, this could be indicative of the floor surface having been cleaned up in the time between the creation of the cleaning order at the accessory device and the floor cleaning apparatus reaching the user location. On the other hand, however, this could be indicative of an erroneous localization of the accessory device and/or the floor cleaning apparatus and a necessity for a corresponding re-calibration of the localization of components of the floor cleaning system.

A message from the floor cleaning apparatus can be signaled to the user visually at a display unit and/or acoustically at a speaker unit, for example.

The operating unit of the accessory device can be differently configured for receiving an instruction.

By way of example, the operating unit preferably has a touch-sensitive or haptic configuration through pressure control and/or gesture control, wherein the operating unit is or comprises a touchscreen in particular. For example, an application program is executably stored in the accessory device, said application program representing a user interface at the operating unit. The application program can be operated via the touchscreen for example.

Alternatively or in addition, the operating unit can have audio configuration through voice control, wherein the operating unit is or comprises a microphone. For example, it is conceivable for cleaning orders to be dictated into the accessory device by the user (“This place needs cleaning.”; “Please remove the dirt in the beverage department.”. . . ).

It is also conceivable for the operating unit to be of inertia-based and/or tilt-based configuration, wherein the operating unit comprises at least one inertial sensor and/or tilt sensor. Thus, provision may be made for an action of shaking the accessory device which is carried out similarly to a swiping or sweeping motion to be interpreted by the application program as a cleaning order to clean the floor surface at the user location.

In particular, the application program stored in the accessory device can be interpreted by the control unit. The application program can be configured as what is known as an “app”, which is provided by a manufacturer of the floor cleaning apparatus for example. To this end, the floor cleaning system can comprise a data processing unit in the possession or under the administration of the manufacturer of the floor cleaning apparatus, from which data processing unit the application program can be loaded by the user for storage and execution on the accessory device.

It is understood that the aforementioned localization member, dirt detection member, storage member and/or communication member of the accessory device may be integrated in or comprised by the control unit thereof.

Correspondingly, provision may be made for the localization member, storage member, dirt detection member and/or communication member of the floor cleaning apparatus to be integrated in or comprised by the control unit thereof.

The accessory device may be a smartphone, a tablet computer or a smartwatch, for example.

The at least one cleaning unit is or comprises a sweeping unit, a scrubbing unit, a wiping unit or a suction unit, for example. The floor cleaning apparatus may be a sweeper machine, a sweeper-vacuum machine, a vacuum machine or a scrubber machine, for example.

As has already been mentioned, the present invention further relates to a method. The object mentioned at the outset is achieved in a method in accordance with the invention for cleaning a floor surface using a floor cleaning system of the kind mentioned above, wherein a cleaning order is triggered to the floor cleaning apparatus by the user via the operating unit of the accessory device and the cleaning order is transmitted to the floor cleaning apparatus to clean the floor surface at the user location, wherein position information relating to the user location is transferred to the floor cleaning apparatus and wherein the floor cleaning apparatus moves to the user location and cleans the floor surface by way of the at least one cleaning unit in accordance with the cleaning order.

The advantages that have been mentioned in the context of the description of the floor cleaning system in accordance with the invention can also be achieved by use of the method in accordance with the invention. In this respect, reference can be had to the foregoing description.

Advantageous exemplary embodiments of the method in accordance with the invention will be apparent from advantageous embodiments of the floor cleaning system in accordance with the invention. In this respect, reference can be had once again to the foregoing description.

In an advantageous exemplary embodiment of the method, provision is made for the user to create an image of the floor surface at the user location, advantageously of the dirt. The image is transferred from the accessory device to the floor cleaning apparatus together with position information which is determined by the localization member of the accessory device on the basis of a relative reference system. The floor cleaning apparatus can orient itself in the relative reference system and moves to the user location. Via an image of the floor surface, the spot of dirt can be located automatically and visited in a targeted manner by the floor cleaning apparatus, wherein the at least one cleaning unit is preset to the type of dirt, which can be detected by way of the dirt detection member. After cleaning the floor surface, the floor cleaning apparatus checks whether or not the floor surface is clean and, if necessary, performs a re-cleaning. A message relating to the completion of the cleaning operation is transmitted to the accessory device and signaled to the user.

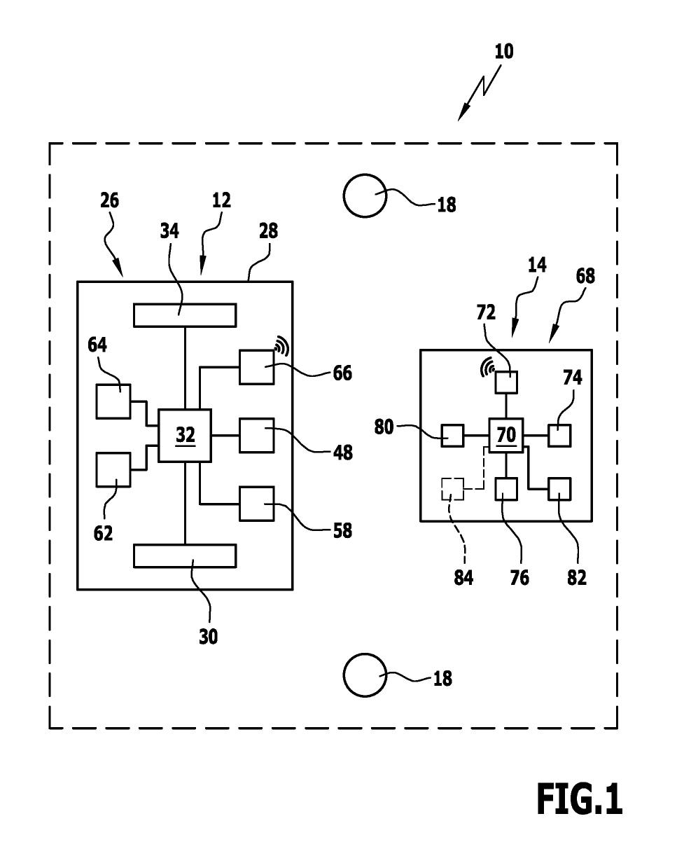

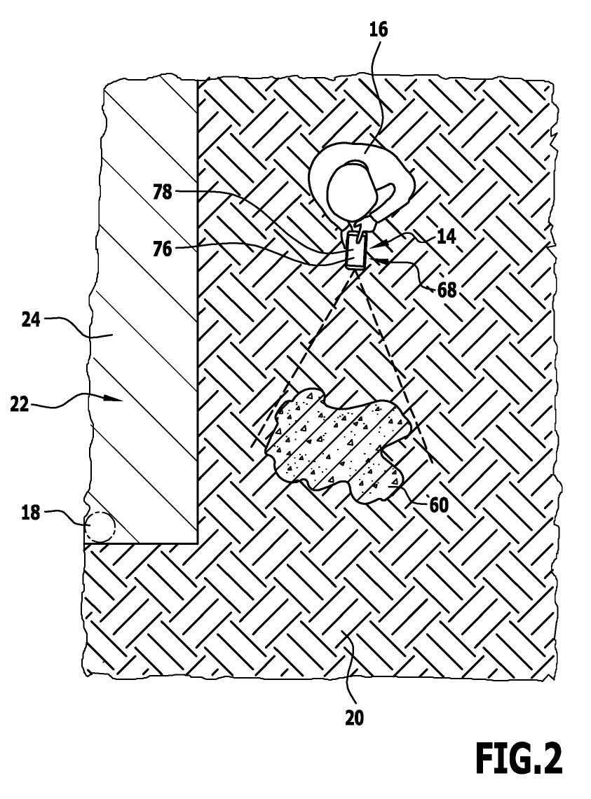

In the drawings, FIG. 1 is a schematic representation of an advantageous embodiment of a floor cleaning system in accordance with the invention, designated by the reference numeral 10. The floor cleaning system 10 comprises a floor cleaning apparatus 12 and at least one portable accessory device 14 for a user 16. Furthermore, the floor cleaning system 10 comprises at least one and preferably a plurality of position landmarks 18. FIG. 1, by way of illustration, shows two position landmarks 18 and FIGS. 2 to 4, by way of illustration, show one position landmark 18.

The floor cleaning system 10 serves to clean a floor surface 20 shown in FIGS. 2 to 4. The floor surface 20 is for example the floor surface of a larger building, such as a supermarket. The floor surface 20 can have areas 22 that are non-navigable for the floor cleaning apparatus 12, one of which is shown schematically in the drawing. In the present case, for example, a shelf 24 of the supermarket is located in the area 22. Alternatively, for example, the area 22 may not be navigated by the floor cleaning apparatus 12 because the floor surface 20 in the area 22 is of a nature that is not designed for this purpose.

In the present case, the floor cleaning apparatus 12 is configured as a cleaning robot with self-propelling and self-steering capability, in particular as a scrubbing machine 26. The floor cleaning apparatus 12 comprises a housing 28 having a chassis 30 held thereto. The chassis 30 comprises wheels and drives for these wheels and can be controlled by a control unit 32, whereby the floor cleaning apparatus 12 can be moved in a targeted manner on the floor surface 20.

The floor cleaning apparatus 12 further comprises at least one cleaning unit 34, at least one of which can be controlled by the control unit 32. In the present case, the cleaning units 34 comprise a cleaning head 36 which forms a scrubbing unit. The cleaning head 36 comprises at least one brush 38 which can be driven in rotation and can be wetted with a cleaning liquid from a storage tank 40 of the floor cleaning apparatus 12. The storage tank 40 is also a cleaning unit 34, as are a dirty-liquid tank 42, a suction unit 44 and a dirt pick-up device 46. Dirt loosened from the floor surface 20 by way of the cleaning head 36 can be sucked off with the dirt pick-up device 46 and transferred to the dirty-liquid tank 42 under the action of the suction unit 44.

Furthermore, the floor cleaning apparatus 12 comprises an optical imaging unit 48 which in the present case comprises two digital cameras 50. A first camera 50 is positioned at a front side 52 of the floor cleaning apparatus 12, relative to the longitudinal direction 54 thereof. A second camera 50 is positioned at a rear side 56 of the floor cleaning apparatus 12.

Furthermore, the floor cleaning apparatus 12 comprises a dirt detection member 58. Images of the floor surface 20 that are transmitted to the floor cleaning apparatus 12 or are created by the imaging unit 48 can be analyzed by the dirt detection member 58. By way of example, the dirt detection member 58 can detect the presence of dirt 60 (FIGS. 2 to 4) on the floor surface 20. The type of dirt can be determined, and corresponding dirt information can be provided to the control unit 32. Based on the dirt information, the control unit 32 can preset at least one cleaning unit 34, for example a contact pressure of the cleaning head 36 and/or the amount of cleaning liquid from the storage tank 40.

For identifying the dirt 60, the dirt detection member 58 can, for example, compare the images of the floor surface 20 with reference images of the floor surface 20 that are stored in a storage member 62 of the floor cleaning apparatus 12. It is also conceivable for the storage member 62 to store therein properties of the floor surface 20, such as the reflectivity thereof, so that dirt 60 can be detected by the dirt detection member 58 by comparing said properties with features extracted from the images.

Furthermore, the storage member 62 can store therein a map of the floor surface 20. The floor cleaning apparatus 12 can determine its position within the map on the basis of the images created by the optical imaging unit 48. The images therefore also serve the purpose of localizing the floor cleaning apparatus 12 on the floor surface 20. To this end, the floor cleaning apparatus 12 comprises a localization member 64. Characteristic features of the images can be extracted and compared with landmarks stored in the map in order to calculate the location and orientation of the floor cleaning apparatus 12.

Furthermore, the localization member 64 enables the position of the floor cleaning apparatus 12 to be determined in a relative reference system. In the present case, the relative reference system is defined by the position landmarks 18. The position landmarks 18 are in particular radio position landmarks and are configured as BLUETOOTH®position landmarks. The building having the floor surface 20 comprises a plurality of position landmarks 18 positioned at selected points and whose relative position to each other is stored in the storage member 62. The position landmarks 18 define a relative reference system within the building.

The localization member 64 can receive radio signals of the position landmarks 18. The radio signals of the different position landmarks 18 differ from one another, whereby the localization member 64 can determine its position and orientation within the relative reference system by evaluating the radio signals. The spatial resolution for position determination is preferably approximately 1 m or less.

Advantageously, the location of the relative reference system is linked to the map in the storage member 62 so that a position within the map can be determined simultaneously on the basis of the coordinates in the relative reference system.

The floor cleaning apparatus 12 further comprises a communication member 66 for data exchange with the accessory device 14. The communication member 66 is a radio communication member for data communication over, for example, a mobile phone network or the internet.

Provision may be made for the dirt detection member 58, the storage member 62, the localization member 64 and/or the communication member 66 to be integrated in or comprised by the control unit 32.

In the present case, the accessory device is configured as a smartphone 68 and comprises a control unit 70. The accessory device 14 comprises a communication member 72 for communication with the communication member 66.

The accessory device 14 further comprises an imaging unit 74 with a digital camera. The user 16 can create images of the floor surface 20 by way of the imaging unit 74.

For operation, the accessory device 14 comprises an operating unit 76 which comprises a touchscreen 78 in particular. The touchscreen 78 serves to receive instructions from the user 16 to the accessory device 14 and to output indications or signals to the user 16.

Furthermore, the accessory device 14 comprises a localization member 80. By way of the localization member 80, the position of the accessory device 14 in the relative reference system defined by the position landmarks 18 can be determined. Corresponding position information can be provided to the control unit 70.

Furthermore, the accessory device 14 comprises a storage member 82. Stored in the storage member 82 is, for example, an application program which can be executed by the control unit 70. By way of example, the application program is configured as what is known as an “app” and is provided by a manufacturer of the floor cleaning apparatus 12. The application program allows the smartphone 68 to be controlled and operated in a user-guided and intuitive manner in order to transmit cleaning orders from the accessory device 14 to the floor cleaning apparatus 12.

Furthermore, the accessory device 14 can comprise a dirt detection member 84. The dirt detection member 84 allows images of the floor surface 20 to be analyzed for dirt and such dirt to be detected and corresponding dirt information to be provided.

The communication member 72, the localization member 80, the storage member 82 and/or the dirt detection member 84 can be integrated in or comprised by the control unit 70.

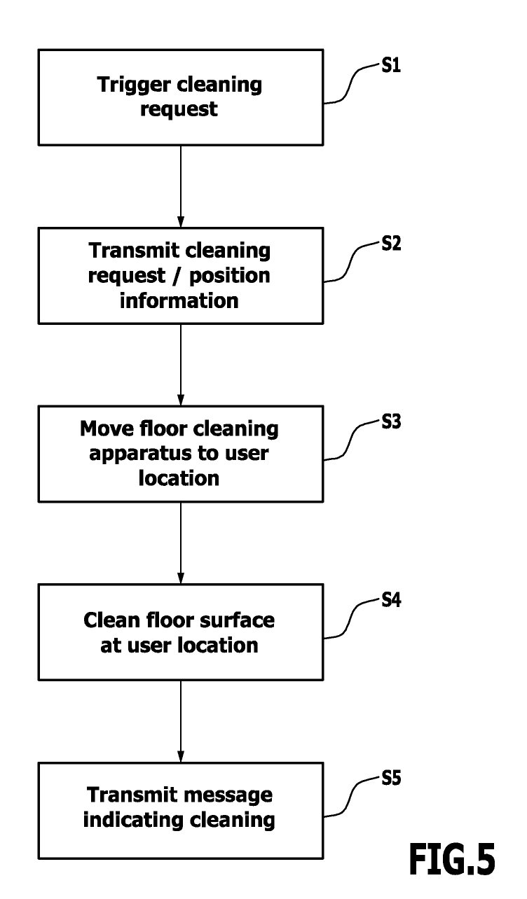

Using the floor cleaning system 10, an advantageous exemplary embodiment of a method in accordance with the invention can be implemented. The exemplary embodiment has the basic structure which is schematically depicted in FIG. 5 and is explained hereinafter in order to illustrate how the floor cleaning system 10 works.

The user 16, who is for example an employee or a manager of the supermarket having the floor surface 20, notices the dirt 60. By way of example, a food product has fallen off the shelf 24, its packaging has burst open and the contents of the packaging now soil the floor surface 20.

In a process step S1, the user triggers a cleaning order to the floor cleaning apparatus 12 at his or her user location. Correspondingly, the origin of the creation of the cleaning order is the user location on the floor surface 20. Preferably, the user location is not limited to the exact geometric position of the user 16 but may be, for example, a few square meters within the range of this exact geometric position.

The cleaning order is triggered by the user 16 via the operating unit 76 of the accessory device 14. To this end, for example, the user 16 invokes the application program in order to trigger the cleaning order. In addition, provision may be made for the user 16 to create an image of the floor surface 20, preferably one in which the dirt 60 is shown (FIG. 1).

In a subsequent step S2, the cleaning order is transmitted to the floor cleaning apparatus 12 via the communication members 72 and 66. In addition, position information relating to the user location is transmitted, wherein the position information is provided by the localization member 80 of the accessory device 14.

The floor cleaning apparatus 12 receives the cleaning order and the position information sent therewith (not shown).

In the subsequent process step S3, the floor cleaning apparatus 12 moves to the user location. To this end, the actual position of the floor cleaning apparatus 12 is determined by way of the localization member 64 thereof. The target position corresponds to the position information of the user location as received by the floor cleaning apparatus 12.

For moving the floor cleaning apparatus 12, the chassis 30 is controlled by the control unit 32 in a manner known per se. The localization of the floor cleaning apparatus 12 can be realized in the relative reference system of the position landmarks 18. Alternatively or in addition, as mentioned, the position information can be transferred to the map stored in the storage member 62. In both cases, the localization and navigation of the floor cleaning apparatus 12 can be realized on the basis of images of the environment of the floor cleaning apparatus 12, in particular the floor surface, said images being created by the optical imaging unit 48.

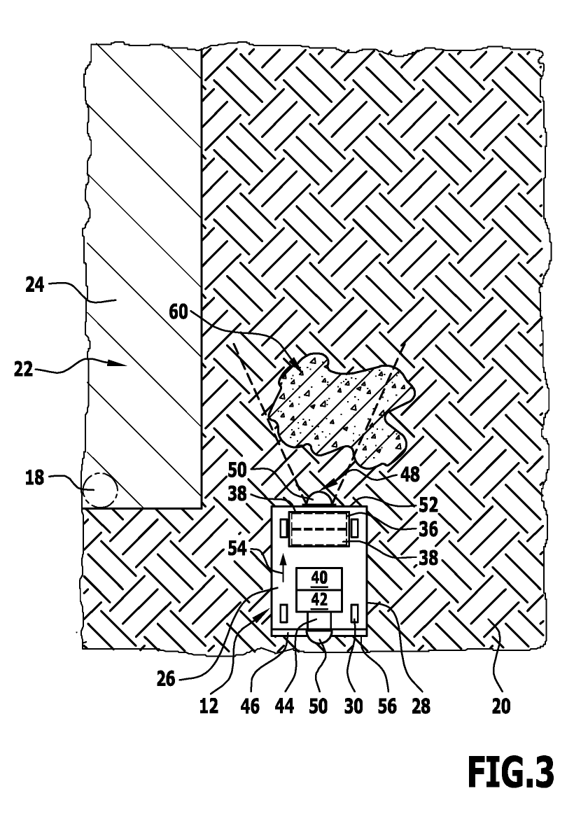

As the floor cleaning apparatus 12 approaches the user location, the presence of the dirt 60 can be detected in the images of the floor surface 20 by way of the dirt detection member 58. The floor cleaning apparatus 12 detects the dirt 60 and determines that it is located at the original location of the user 16 and starts cleaning the floor surface 20. This is shown in FIG. 3.

In the present example, the user 16 has already moved away. However, the location of cleaning order creation has remained unaltered, namely the original user location.

If, as mentioned above, an image of the floor surface 20 has been transmitted from the accessory device 14 to the floor cleaning apparatus 12, this image can be compared with the images created by the imaging unit 48. This makes it easier for the floor cleaning apparatus 12 to locate the dirt 60.

If the dirt 60 is detected by the dirt detection member 58, the spot of dirt 60 can be visited in a targeted manner by the floor cleaning apparatus 12. Alternatively or in addition, it is in particular conceivable that, on the basis of the dirt information provided, at least one cleaning unit 34 is preset and/or a suitable cleaning path or a suitable cleaning pattern is selected for as targeted a cleaning of the floor surface 20 as possible.

Alternatively, provision may be made for the floor cleaning apparatus 12 to move to the user location upon receipt of the cleaning order. Where the floor cleaning apparatus 12 detects no dirt at the user location within the limits of the accuracy of the position determination, it can search a predetermined or predeterminable environment for dirt (for example within a radius of approximately 1 m to 3 m).

In the subsequent process step S4, the floor surface 20 is cleaned at the user location in accordance with the cleaning order. The cleaning process itself is not shown in the drawing.

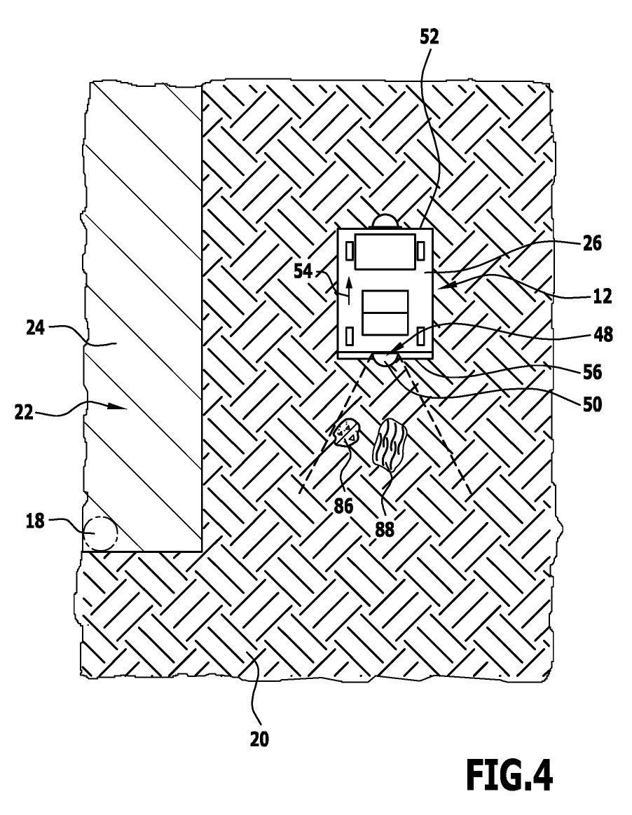

At the end of the process step S4, subsequent to the cleaning, the floor surface 20 is checked for cleanliness. This is shown in FIG. 4. For example, an image of the floor surface 20 is created with the camera 50 at the rear side 56 when moving over the dirt 60 and checked for the presence of dirt. When needed, re-cleaning of the floor surface 20 is performed at the user location.

FIG. 4 shows, by way of illustration, how residual dirt 86 and residual moisture 88 are left on the floor surface 20 after the cleaning process. The floor cleaning apparatus 12 would therefore continue cleaning until a sufficient degree of cleanliness of the floor surface 20 is reached.

In the subsequent process step S5, a message indicating successful cleaning of the floor surface 20 is transferred from the floor cleaning apparatus 12 to the accessory device 14. The message is displayed to the user 16 on the display of the touchscreen 78. An audible indication is also possible (not shown).

By way of the floor cleaning system and method in accordance with the invention, it is possible to realize targeted, needs-dependent cleaning of the floor surface 20, triggered by the user 16. Spatially limited spots of dirt 60 can be visited in a targeted manner and removed by the floor cleaning apparatus 12.

Reference is made to the further advantageous embodiments of the floor cleaning system and exemplary embodiments of the method that have already been described above. In particular, the invention may be implemented in the following way:

The user 16 transmits an image of the floor surface 20 to the floor cleaning apparatus 12. The image simultaneously comprises the position information because the characteristic features in the image can be utilized by the floor cleaning apparatus 12 in order to determine the user location.

The cleaning order does not contain a transmitted image. Thus, for example, in particular the transmission of position information from the accessory device 14 to the floor cleaning apparatus 12 alone can be regarded as a cleaning order to clean the floor surface 20 at the user location.

The dirt 60 is already detected in the accessory device 14 by the dirt detection member 84 and dirt information is transmitted to the floor cleaning apparatus 12 as part of the cleaning order. The dirt information can also comprise information relating to the type of dirt for possible setting of a cleaning unit 34.

The user 16 can provide dirt information about the type of dirt and/or a cleaning instruction for preselecting a cleaning unit, a cleaning pattern or a cleaning path at the operating unit 76.

### LIST OF REFERENCE NUMERALS

10 floor cleaning system
12 floor cleaning apparatus
14 accessory device
16 user
18 position landmark
20 floor surface
22 area
24 shelf
26 scrubbing machine
28 housing
30 chassis
32 control unit
34 cleaning unit
36 cleaning head
38 brush
40 storage tank
42 dirty-liquid tank
44 suction unit
46 dirt pick-up device
48 optical imaging unit
50 camera
52 front side
54 longitudinal direction
56 rear side
58 dirt detection member
60 dirt
62 storage member
64 localization member
66 communication member
68 smartphone
70 control unit
72 communication member
74 imaging unit
76 operating unit
78 touchscreen
80 localization member
82 storage member
84 dirt detection member
86 residual dirt
88 moisture

1. A floor cleaning system, comprising
a self-propelled and self-steering floor cleaning apparatus for cleaning a floor surface, which floor cleaning apparatus comprises a control unit, a controllable chassis, at least one cleaning unit, a localization member and a communication member; and
a portable accessory device for a user that comprises an operating unit, a control unit and a communication member,
wherein a cleaning order to the floor cleaning apparatus is triggerable by the user via the operating unit and said cleaning order is transmittable to the floor cleaning apparatus to clean the floor surface at the user location, wherein position information relating to the user location is transferable to the floor cleaning apparatus and wherein the floor cleaning apparatus is movable to the user location and the floor surface at the user location is cleanable in accordance with the cleaning order by way of the at least one cleaning unit.

2. The floor cleaning system in accordance with claim 1, wherein the position information is transmittable from the accessory device, together with or as part of the cleaning order.

3. The floor cleaning system in accordance with claim 1, wherein the user location is predeterminable at the accessory device by a user via the operating unit.

4. The floor cleaning system in accordance with claim 1, wherein the accessory device comprises a localization member by way of which the user location is determinable for providing the position information based on at least one of the following:
the position of the accessory device in a relative reference system which is defined on the basis of at least one position landmark;
the position of the accessory device in an absolute reference system.

5. The floor cleaning system in accordance with claim 1, wherein the floor cleaning system comprises a localization member by way of which the position of the user is determinable, and wherein the position information is transmittable from the localization member to the floor cleaning apparatus upon request thereof.

6. The floor cleaning system in accordance with claim 1, wherein the accessory device comprises a storage member in which a map of the floor surface is stored, and a localization member for determining the user location within the map for providing the position information.

7. The floor cleaning system in accordance with claim 1, wherein the location of the floor cleaning apparatus is determinable by way of a localization member thereof using at least one of the following:
a relative reference system which is defined by at least one position landmark;
the absolute reference system;
a map of the floor surface which is stored in a storage member of the floor cleaning apparatus.

8. The floor cleaning system in accordance with claim 1, wherein a localization member of the accessory device and/or a localization member of the floor cleaning apparatus are configured for interacting with at least one of radio position landmarks and optical position landmarks.

9. The floor cleaning system in accordance with claim 1, wherein the floor cleaning system comprises at least one position landmark for defining a relative reference system.

10. The floor cleaning system in accordance with claim 1, wherein the accessory device comprises an imaging unit with which an image of the floor surface is creatable and wherein at least one of the following is performable:
the image is transferred to the floor cleaning apparatus, wherein, by way of a localization member thereof, the user location is determinable on the basis of characteristic features in the image;
the user location is determined on the basis of characteristic features in the image by way of a localization member of the accessory device.

11. The floor cleaning system in accordance with claim 1, wherein the floor cleaning apparatus takes the receipt of an optical image of the floor surface, transmitted from the accessory device, as a cleaning order to clean the floor surface at the position shown in the image.

12. The floor cleaning system in accordance with claim 1, wherein the floor cleaning apparatus comprises an imaging unit for creating images of the environment and wherein, by way of the floor cleaning apparatus, on the basis of a localization member thereof, its own location within the environment is determinable on the basis of said images.

13. The floor cleaning system in accordance with claim 1, wherein the floor cleaning system comprises, in the accessory device and/or in the floor cleaning apparatus, at least one dirt detection member for locating dirt in an image of the floor surface that has been created by an imaging unit of the accessory device or of the floor cleaning apparatus and for providing a corresponding dirt information.

14. The floor cleaning system in accordance with claim 13, wherein, based on the dirt information, the spot of dirt at the user location is visitable in a targeted manner by the floor cleaning apparatus for cleaning.

15. The floor cleaning system in accordance with claim 1, wherein the cleaning order comprises at least one of dirt information relating to a type of dirt on the floor surface and a cleaning instruction comprising information relating to the preselection and/or setting of at least one cleaning unit.

16. The floor cleaning system in accordance with claim 15, wherein at least one of the dirt information and the cleaning instruction is predeterminable by the user at the operating unit.

17. The floor cleaning system in accordance with claim 15, wherein, depending on the dirt information, a cleaning mode is settable or selectable by the floor cleaning apparatus prior to cleaning, for example at least one cleaning unit and/or at least one cleaning pattern or cleaning path.

18. The floor cleaning system in accordance with claim 1, wherein at least one of the following is performable by the floor cleaning apparatus after execution of the cleaning order:
the floor surface is checked for cleanliness;
a message is sent to the accessory device for signalling the user that the floor surface has been cleaned at least once.

19. The floor cleaning system in accordance with claim 18, wherein, if it is determined that the floor surface is not sufficiently clean, at least one further cleaning of the floor surface is performable by the floor cleaning apparatus.

20. The floor cleaning system in accordance with claim 1, wherein a message is transmittable from the floor cleaning apparatus to the accessory device for signalling the user if no dirt can be located at the user location.

21. The floor cleaning system in accordance with claim 1, wherein the operating unit of the accessory device is configured according to at least one of the following for receiving an instruction:
touch-sensitive or haptic through at least one of pressure control and gesture control, wherein the operating unit is or comprises a touchscreen;
audio through voice control, wherein the operating unit is or comprises a microphone;
inertia-based, wherein the operating unit comprises at least one inertial sensor;
tilt-based, wherein the operating unit comprises at least one tilt sensor.

22. The floor cleaning system in accordance with claim 1, wherein the accessory device is a smartphone, a tablet computer or a smartwatch.

23. The floor cleaning system in accordance with claim 1, wherein the at least one cleaning unit is or comprises a sweeping unit, a scrubbing unit, a wiping unit or a suction unit.

24. A method for cleaning a floor surface using a floor cleaning system, the cleaning system comprising
a self-propelled and self-steering floor cleaning apparatus for cleaning a floor surface, which floor cleaning apparatus comprises a control unit, a controllable chassis, at least one cleaning unit, a localization member and a communication member; and
a portable accessory device for a user that comprises an operating unit, a control unit and a communication member,
wherein a cleaning order is triggered to the floor cleaning apparatus by a user via the operating unit of the accessory device and the cleaning order is transmitted to the floor cleaning apparatus to clean the floor surface at the user location, wherein position information relating to the user location is transferred to the floor cleaning apparatus and wherein the floor cleaning apparatus moves to the user location and cleans the floor surface by way of the at least one cleaning unit in accordance with the cleaning order.
